(19) United States
(12) Patent Application Publication
(10) Pub. No.: US 2005/0130725 A1
(43) Pub. Date: Jun. 16, 2005

(54) Combined virtual and video game

(75) Inventors: Thomas E. Creamer, Boca Raton, FL (US); Peeyush Jaiswal, Boca Raton, FL (US); Zygmunt A. Lozinski, Cambridge (GB); Victor S. Moore, Boynton Beach, FL (US); Christopher E. Sharp, Hampshire (GB)

Correspondence Address: AKERMAN SENTERFITT, P. O. BOX 3188, WEST PALM BEACH, FL, 33402-3188, US

(73) Assignee: International Business Machines Corporation, Armonk, NY (US)

(21) Appl. No.: 10/736,144

(22) Filed: Dec. 15, 2003

(51) Int. Cl. G06F 17/00

(52) U.S. Cl. 463/1

(57) ABSTRACT

A method of providing a video game that tracks events in an actual sporting event can include generating a virtual environment, generating one or more first virtual characters in the virtual environment, receiving event data specifying events of a sporting event, coordinating actions of the first virtual character according to the event data, and generating one or more user-controlled second virtual characters. A system for providing a video game experience that tracks events in an actual sporting event is also provided. The system includes one or more gaming systems for receiving event data containing events of a sporting event, and one or more gaming engines for generating a virtual environment having one or more first virtual characters where the actions of the first virtual character are based on the event data.

### BACKGROUND OF THE INVENTION

1. Technical Field

This invention relates to the field of video games and, more particularly, to video games that attempt to provide an experience based on reality.

2. Description of the Related Art

Video games arose from simple games, such as electronic card games, that were traditionally played by a single user engaging a single machine. These early video games usually consisted of text or rudimentary graphics to display information to the user. Such early video games generally allowed a user to compete against a virtual computer player that typically followed a set of rules for executing pre-programmed actions or moves.

Video games advanced to include complex three dimensional graphics that submerged a three dimensional character in a virtual three dimensional world. The video game player typically controlled the actions and movements of a character that were displayed on a video screen. The virtual world, while appearing to be limitless, sets boundaries by instituting rules defining how the characters can interact with each other and the virtual world. These rules are usually preprogrammed and set some limits to the user's interaction. Nevertheless, the virtual world can provide a user experience of being absorbed in a virtual environment that is independent from outside influence.

With the rise of high speed communication networks, and particularly the evolution of the Internet, video games have again transformed to provide a new user experience. Gaming engineers again created three dimensional virtual worlds that allowed players to interact with the world; however, the high speed communication networks allowed a plurality of individual players to simultaneously control at least one figure in the virtual world. This allowed multiple players, from any location with access to a communications network, to interact with the characters controlled by other users.

In operation and occurring in real-time, game players see the movements and interactions of not only the character that they control, but also see the movements and actions of characters controlled by others. With such a system, a video game player in America can interact, through the use of game characters, with a video game player in Asia in the universal language provided by the video game. Thus, while video games still incorporate elements of competition and provide a relaxing and enjoyable experience, video games have transformed to provide not only a form of contemporary entertainment, but also a form of contemporary communication that can bridge language, religion, political, and social-economic barriers.

Despite recent advances in video game technology that marvels video game technology touted as groundbreaking just a few years ago, video game players exhibit an insatiable desire for ever increasing realistic video game experiences, i.e. video game experiences that are as life-like a possible. While the software and the hardware technology both have made persistent and appreciable developments that have directly resulted in complex graphics that appear to closely mimic reality, video games are limited to functioning within a set of preprogrammed rules which limits the user's interaction with the virtual worlds and characters within those worlds. Thus, the user's experience can only be as life-like as the video game is programmed to provide.

### SUMMARY OF THE INVENTION

The invention disclosed herein provides a method, system, and machine readable storage for providing a video game that tracks events in an actual sporting event. The present invention not only tracks the events in an actual sporting event, but also can dynamically update game content to allow the user to control virtual characters that can interact with the virtual characters who represent individual sport participants from the sporting event. Accordingly, a user can “play” against a virtual opponent based on players in a real sporting event in near real time with the events of the sporting event.

A method of providing a video game that tracks events in an actual sporting event can include generating a virtual environment and generating one or more first virtual characters in the virtual environment. The method can also include receiving event data specifying events of a sporting event, coordinating actions of the first virtual character according to the event data, and generating one or more user-controlled second virtual characters. The second virtual character can interact with the first virtual character and the actions of the first virtual character can occur in near real time with the sporting event. The event data can specify the sporting event environment and the method can include modeling the virtual environment on event data.

The method can also include updating game content having portions derived from event data and portions derived from user input. The method can also include correlating the actions of individual first virtual characters with the actions of an individual sporting event participant according to the event data. The first virtual character can include a plurality of first virtual characters. Additionally, user input can be received where the user input can control actions of one or more second virtual characters. The second virtual character can include a plurality of virtual characters. The method can further include presenting the interaction of the first virtual character and second virtual character. The event data can be produced manually.

In accordance with the inventive arrangements, a system for providing a video game experience that tracks events in an actual sporting event is disclosed. The system can include one or more gaming systems for receiving event data containing events of a sporting event and one or more gaming engines for generating a virtual environment having one or more first virtual characters where the actions of the first virtual character are based on the event data. The event data can specify the environment of the sporting event and the gaming engine can generate the virtual environment based on the sporting event environment.

The gaming engine can generate one or more user-controlled second virtual characters and the second virtual character can interact with the first virtual character. The actions of the first virtual character can occur in near real time with the sporting event. Further, the gaming engine can update game content having portions derived from event data and portions derived from user input. The gaming engine can correlate the actions of individual first virtual characters with the actions of an individual sporting event participant according to the event data.

The present invention further can be embodied as a machine readable storage for causing a machine to perform the steps as described herein as well as a system having means for performing the steps disclosed herein.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a schematic diagram illustrating a system for providing a video game experience that tracks events in an actual sporting event in accordance with the inventive arrangements disclosed herein.

FIG. 2 is a flow chart illustrating a method of providing a video game that tracks events in an actual sporting event in accordance with the inventive arrangements disclosed herein.

### DETAILED DESCRIPTION OF THE INVENTION

The invention disclosed herein provides a method, system, and machine readable storage for providing a video game that tracks events in an actual sporting event. The video game can be a multiplayer sporting event game that permits a multitude of geographically disperse computer users to interact with one another within the multiplayer gaming environment. Further, input from a live sporting event, such as a football game, can be interactively integrated into the multiplayer video game. Events occurring in an actual sporting event can be tracked and can cause changes to occur within the virtual environment represented by the video game. For example, a virtual character in the video game can exhibit behavior based upon a real world actions. Accordingly, the present invention can allow one or more computer users to “play” against a virtual opponent and/or other computer users based on activities occurring within in a real sporting event in near real time with the events of the sporting event.

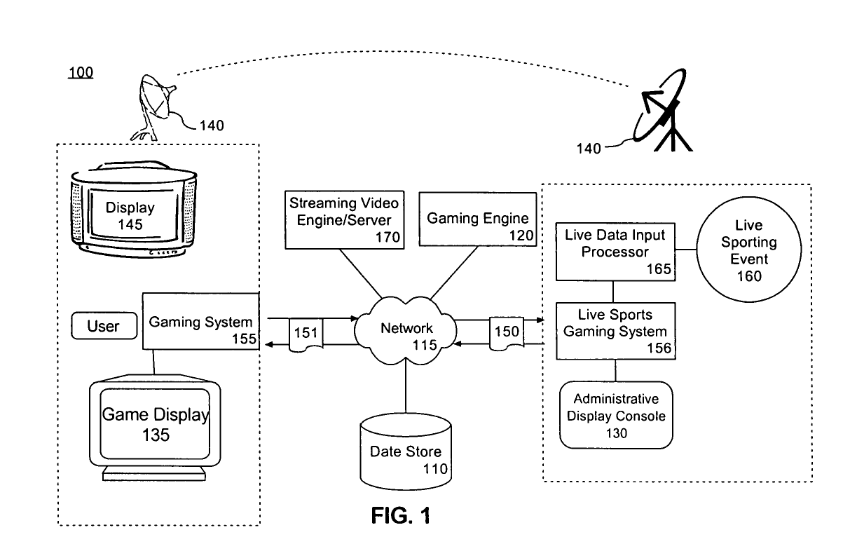

FIG. 1 is a schematic diagram illustrating an exemplary system 100 for providing a video game experience that tracks events in an actual sporting event. The system 100 can include a network 115, one or more gaming engines 120, and a streaming video engine/server 170. The system 100 can also include one or more administrative display consoles 130, one or more game displays 135, one or more gaming systems like gaming system 155 and 156, and one or more line data input processors 165. Additionally, the system 100 can include a broadcast system 140 for broadcasting and audiovisual feed of a live sporting event 160 to a display 145, which can include speakers, for presenting the audiovisual feed of the live sporting event 160. The system 100, however, can function independently of the broadcast system 140 and the display 145.

The network 115 can communicatively link the gaming engines 120, the streaming video engine/servers 170, administrative display consoles 130, and game displays 135. The network 115 can utilize any communication medium to facilitate information exchange within the system 100. For example, the network 115 can include, but is not limited to, line-based pathways and wireless pathways such as the Public Switched Telephone Network, mobile networks, wireless networks, satellite networks, cable systems, networks configured according to one of the 802.11 family of communication protocols, and the like. Moreover, the network 115 can include global networks, local networks, the Internet, intranets, and other sub-networks.

The gaming engine 120 can be a computer program executing within a suitable information processing system. The gaming engine 120 can function as a multiplayer game server for a multitude of game clients, such as gaming system 155 and 156. That is, the gaming engine 120 can produce the summation of the visual effects, interactions, sound effects, and the like, that collectively form a game. The gaming engine 120 can further coordinate live data 150 and gaming data 151 so that events in the game are affected by the live data 150 and the gaming data 151.

The gaming engine 120 can include industry standard components for generating the virtual game information such as a graphic or animation rendering engine for generating visual effects and presentations, scripting systems for producing actions that are not user influenced, and other customized components for particular actions, visual effects, and interactions within the game. The gaming engine 120 can also stream video from the live sporting event to game clients using the streaming video engine/server 170.

The gaming engine 120 can be programmed with virtual game information, such as environment information, team information, and player information, from which a complete virtual environment can be built and operated. Data necessary for these customizations used by the gaming engine 120 can be stored within data store 110. The data related to the sporting event can provide at least a portion of the game content and can include assets such as models of virtual sport participants, animations, sounds, and the physics or rules of the game. Accordingly, virtual game information can include the layout of sporting event venues, such as stadiums, fields, tracks, and the like. The virtual game information can also include attributes of individual teams, such as team uniforms, team rosters, team songs, team playbooks and formations, and the like.

In one embodiment, the virtual game information can include individual player attributes, such as name and number, height, weight, build, signature moves and celebrations, and the like. It should also be noted that individual player attributes can also include a characterization of the players abilities, such as a speed rating, a fatigue rating, an error rating, that can be based on the real life player. Such individual player attributes can be represented by a programmatic model, for example one using artificial intelligence, generated for each individual player or for groups of players.

In another embodiment, the gaming engine 120 can generate the virtual environment including a graphical representation of objects and the boundaries of the virtual environment as specified in the virtual game information and the event data 150. Typically, the virtual environment can be represented in two or three dimensions having ground surface, an appearance of a sky, and other items placed throughout the virtual environment. For instance, if the video game is centered around American football, the environment can include a graphical representation of a football field, complete with field markings, field goals, and even a stadium. Similarly, the gaming engine 120 can be used to generate the virtual characters for interacting in the virtual environment.

In yet another embodiment, the virtual game information can dynamically extract data from the live sporting event 160. The live data input processor 165 can automatically extract data provided by live sporting event 160 and adapt the data for the gaming engine 120. The live data input processor 165 can utilize jersey numbers, body shapes, facial recognition, and the like to identify particular players involved in a sporting event. Once individual players have been identified, the actions occurring during the live sporting event 160 can be automatically quantified using heuristics and/or algorithms based upon the live game. The quantified actions can be used as a basis to control a virtual character in the gaming engine 120.

For example, if a player is injured during the live sporting event 160, the live data input processor 165 can automatically generate suitable health parameters, fatigue characteristics, unavailability timers, and the like for that player. This data from the live data input processor 165 can be used by the gaming engine 120 to adjust the behavior and/or capabilities of a related virtual player in near real time.

In one arrangement, the live data input processor 165 can be dynamically linked to a Web site and/or other data feed separate from the broadcast or data output of the live sporting event 160, such as the feed that permits sporting event scores and statistics to be provided upon pagers, sports tickers, and the like. In such an embodiment, the live data input processor 165 can integrate data from the data feed with the data provided directly from the live sporting event 160 data source.

The administrative display console 130 can be used to administratively adjust processing parameters of the live data input processor 165 and/or the live sporting event 160. For example, if multiple camera perspectives are available for a live sporting event 160 the administrative display console 130 can be used to select a primary video source or perspective that is to be used by the gaming engine 120. In another example, the administrative display console 130 can permit an administrator to manually input data for the live sporting event. The administrator provided input can be used to manually override data automatically generated by the live data input processor 165. For example, when the live data input processor 165 incorrectly identifies a player using automated identification routines, the administrative display console 130 can be used to dynamically adjust the identity of the player.

The gaming system 155 and/or 156 can include an information processing system having suitable hardware and software for interpreting received information from the gaming engine 120 and for communicating with the various components of system 100. For example, the gaming system 155 and/or 156 can include a personal computer system, a handheld device, or the like. The gaming system 155 and/or 156 can also include a keyboard, a mouse or other controller such as a joystick, activatable buttons, and the like for inputting gaming commands and making selections. Further, the gaming system 155 and/or 156 can generate the visual and audible effects specified by received information from the gaming engine 120. Additionally, the gaming system 155 and/or 156 can generate one or more graphical user interfaces that present information to the user and allow the user to navigate and input information into system 100. The gaming system 155 and/or 156 can also include a transceiver having appropriate circuitry for communicating over the network 115. The transceiver can be implemented as a wired or wireless modem, a network interface card, a network port, and the like that enables communication with the network 115.

In one embodiment, different versions of the virtual game can be provided by the gaming engine 120 based upon the capabilities available to different users. For example, the gaming engine 120 can present a basic version of the virtual game to home users utilizing gaming system 155. A more robust version of the gaming system can be presented to cyber cafes and sports bar having significant available bandwidth for communications with the gaming engine 120, having non-standard computing components like multiple displays or holographic displays, and/or having a commercial subscription instead of a residential subscription for the gaming engine 120.

In another embodiment, the gaming system 156 can include extra features for including input directly from the live sporting event 160 and/or the administrative console 130. For example, the gaming system 156 can include a window for playing the live broadcast of the sporting event without the broadcast being processed through the gaming engine 120. The gaming system 156 can also be tailored by the administrative console 130.

For example, an administrative display console 130 for a sports bar can be interconnected to a multitude of gaming systems 156 local to the sports bar. Patrons using the local gaming systems 156 can compete with one another using the gaming engine 120 customized locally by the administrative display console 130. For example, the administrative display console 130 can establish prizes for local patrons based upon their proficiency with the gaming system 156. Further, the administrative display console 130 can permit locally established advertising, music, and virtual players to appear within the gaming system 156. For example, administrative console 130 can adjust the appearance of the officials within the video game to resemble employees working at the sports bar.

In an illustrative example, the gaming engine 120 can include a virtual bar environment in which computer users of gaming systems 155 and 156 can interact. The virtual bar can include virtual televisions playing video based upon live sporting event 160. The displays of the virtual televisions can present video provided via the streaming video engine/server 170. Further, the live data input processor 165 can extract data based upon the live sporting event 160 so that the gaming engine 120 can properly interpret live events. For example, the live data input processor 165 can determine player statistics, game scores, and the like. Computer users in the virtual bar can place bets with one another and with virtual bookies based upon the outcome of the live sporting event 160 being played within the virtual bar. Further, plot events for the video game can be triggered by events occurring within the live sporting event 160. For example, virtual bar patrons cheering for rival sporting teams can start a fight based on a controversy occurring within the live sporting event, such as a poor officiating call or a change of possession.

It should be noted that the gaming engine 120 need not be deterministically based directly upon events occurring within the live sporting event 160, but can instead be based upon data from the live sporting event 160 combined with customizable parameters established for the gaming engine 120. For instance, the gaming engine 120 can include a set of virtual stadiums in which real world sporting events can be transposed. Events occurring within a live sporting event can be virtually altered for a different one of the virtual stadiums. For example, a particular virtual baseball field can be more or less difficult to hit home-runs in than a baseball field in which a real world sporting event is taking place. Accordingly, some of the actions occurring within the real sporting event, such a home run, may have a slightly different effect, such as a double, in the virtual environment provided by the gaming engine 120. Any of a variety of real world conditions can be modified within the virtual gaming environment and suitable adjustments can be performed. For example, conditions such as weather, spectator turnout, daylight, and the like can be adjusted by the gaming engine 120.

The gaming engine 120 can also generate one or more user controlled second virtual characters. Similar to the first virtual characters, gaming engine 120 can be programmed with sets and subsets of different characters, their physical characteristics and attributes, signature moves, and the like. One or more of the second virtual characters can be user controlled through the user interface 155 and viewed by the user on the game display 135. The characteristics of the virtual characters can be based on the current statistics of real world sports players, that can be automatically adjusted as the live sporting events 160 occur.

For example, the chances that a virtual batter hits a pitch can be based on the batting average of a current real world sports figures. Such batting averages can be dynamically modified as sports games are played. Further, adjustments can be made for virtually constructed players in accordance to a hot streak or a cold streak that a real world player is having. Dynamically adjusting game behavior based upon real-world situations can resulting in significantly more realistic game play than that which is provided by conventional techniques.

In one embodiment, the gaming engine 120 can include sufficient artificial intelligence to create a virtual amalgamation involving players in the live sporting event 160 and one or more virtual players controlled by users of the gaming system 155 and/or 156. One illustrative example of such an embodiment can be a baseball game. In the exemplary baseball game, a computer user may control a batter, another virtual user may control a pitcher, and the infield and outfield baseball players can be virtual characters whose actions are based on the actions of the infield and outfield players of the live sporting event 160. In the live sporting event 160, the infield and outfield players can position themselves for a long range hitter and the first virtual characters can also be positioned similarly. In the live sporting event 160, such an arrangement can be effective if the batter hits a long range ball; however, in the virtual environment with the batter controlled by the user, the user may decide to hit a short ball by bunting instead of swinging. Accordingly, although the first virtual characters actions can be based on the actions of the live game, the first virtual characters can react to actions produced by user choices in the actions of the second virtual character. The gaming engine 120 can update the game content as the first and second virtual characters interact and as play progresses.

If the user is positioned to view both the display 145 and the game display 135, the user will be able to watch the live game. As the live sporting event 160 progresses and after plays are completed, the operator can input event data 150 to the system 100. Thus, in near real time with the sporting event of the live sporting event 160 or just after a play or action takes place in the live sporting event 160 and the user has viewed the live game, the user will be able to control the second virtual character against the actions just completed in the live sporting event 160. In such an arrangement, the user will be able to immediately “second guess” the player actions and coach's play choice to see if the user can produce a winning result.

In such an arrangement, the gaming system 155 can prompt the user for input prior to completion or commencement of an event and/or action in the live sporting event 160. In response, the user can input instructions via the user interface 155. The user can then view the display 145 to watch how the action developed and resulted in the live sporting event 160. Immediately after the event and/or action has completed in the live sporting event 160, the user can control the second virtual characters, initially using the instructions input moments earlier and adapting as the virtual game progresses in the virtual environment. Thus, the user will not only be able to “second guess” the action in the live sporting event 160, but will also be able to control the second virtual characters to see the results of such a “second guess.” After action is completed in the virtual environment, the virtual environment can reset to allow the user again to input user instructions prior to completion or commencement of an event and/or action in the live sporting event 160.

In another embodiment, the display 145 and the game display 135 can be combined as a single display. In such an arrangement, the display can include a bifurcated screen for showing the audiovisual transmission of the live sporting event 150 as well as the virtual video game at the same time. Also, the display can be configured to alternate the display of the live sporting event 160 and the virtual video game.

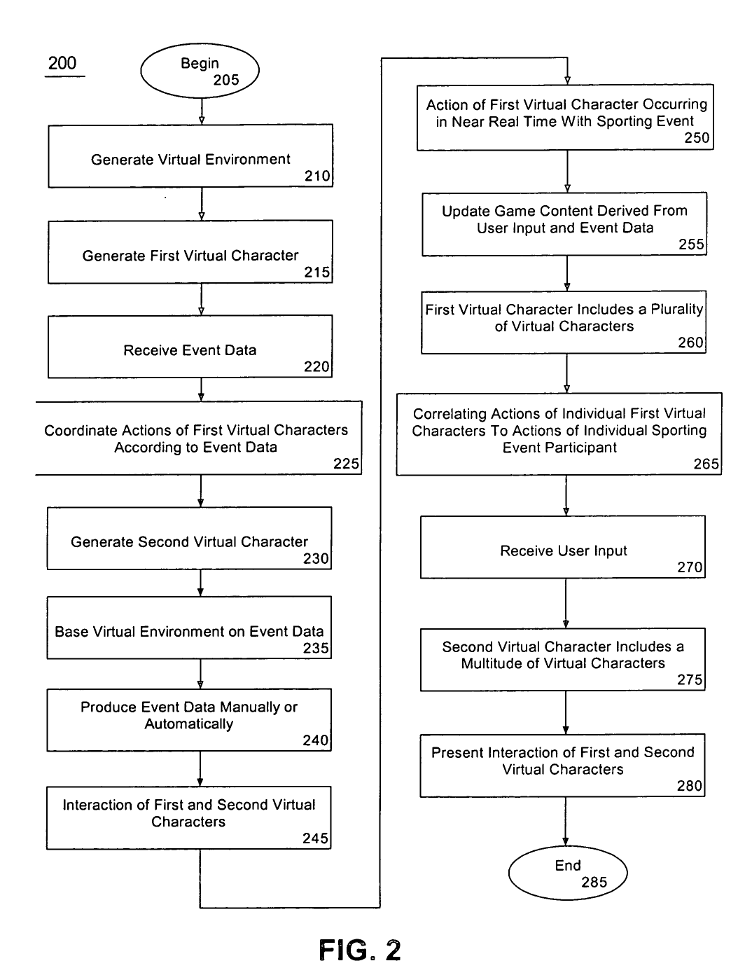

FIG. 2 is a flow chart illustrating method 200 for an multiplayer video game responsive to live sporting event data in accordance with the inventive arrangements disclosed herein. The method 200 can be performed in the context of a multiplayer video game communicatively linked to one or more remotely located game clients. The method can begin at step 205, where the multiplayer video game can be instantiated.

In step 210, a virtual environment can be generated by the video game. Generally, a virtual environment can include a graphic pictorial representation of a three-dimensional world. Generating the virtual environment can also include defining the physics that will control the action and interaction of characters within the virtual environment. The virtual environment can include all the features of the environment of the sporting event, such as the stadium, the crowd number, the weather conditions, and the like. It should be noted that the virtual environment can be based on any particular environment and is not limited to mimicking the environment of the sporting event. For instance, the virtual environment can mimic a particular stadium while the sporting event is occurring at a different stadium.

In step 215, one or more first virtual characters can be generated in the virtual environment. The first virtual characters can be based on the participants of the sporting event. Accordingly, if the sporting event is an American football game, then the first virtual characters can be generated to mimic one of the teams participating in the game. In one embodiment, generating the first virtual characters can include generating a programmatic model, such as one using artificial intelligence, for each virtual player where the physical attributes are based on the physical attributes of a particular sport participant.

In step 220, event data specifying the events of the sporting event can be received. It should be noted that the event data can include particular environment conditions, actions of particular sport participants, weather conditions, and the like. The event data can be received in near real time with the occurrence of the event in the sporting event and can also be received after a brief or extended delay.

Turning to step 225, the actions of the first virtual characters can be coordinated according to the event data. In such an arrangement, the first virtual character's actions, formations, and interactions can be coordinated to mimic the actions of the participants of the sporting event as specified by the event data. Thus, if the participants of the sporting event are moving in one direction, the first virtual characters will also move in the same direction, or in a like manner, in the virtual environment.

In step 230, one or more user-controlled second virtual characters can be generated. The second virtual characters, similar to the first virtual characters, can be generated to mimic the participants of the sporting event. For example, generating the second virtual characters can include generating a entire team which is an opponent in the sporting event.

In step 235, the event data can include the sporting event environment and the virtual environment can be based on the event data. For instance, the event data can include sporting event environment information such as weather conditions and field conditions. Further, the event data can include the stadium description and other environment information. It is also important to note that the event data can include ongoing changes in the sporting environment. For instance, the event data can include crowd reactions which can be used to dynamically change the crowd in the virtual environment. Accordingly, when a crowd cheers at the sporting event, the virtual environment can be dynamically updated so that the virtual crowd also cheers.

In step 240, the event data can be produced manually or automatically. In manual production of the event data, one or more operators can watch a sporting event and manually enter plays, sporting event participant actions, and general sporting event environment conditions and changes. To speed the entering of such information, preprogrammed entries can be available for selection. Further, while entries can be made for particular individual sporting event participants, some global entries can be made to effectively describe the sporting event participants general movements, such as the execution of a particular play. Automatically produced event data can be dynamically generated by a processing engine, such as the live data input processor 165 of FIG. 1.

In step 245, the second virtual character can interact with the first virtual character. The movements, actions, and stances of the second virtual character can affect the first virtual character, and cause the first virtual character to thereby adapt its movements, actions, and stances. Similarly, the first virtual character can cause the second virtual character to adapt and alter its movements, actions and stances. The characters can also physically interact in the virtual world, for example by touching, pushing, blocking each other.

In step 250, the actions of the first virtual character can occur in near real time with the sporting event. For instance, almost immediately after action occurs in the sporting event, or a play is completed in a sporting event, the first virtual characters can commence their actions in the virtual environment. Such near real time commencement of actions allows the action on the virtual environment to only slightly lag the occurrence of the action in the sporting event.

In step 255, game content can be updated where portions of the game content are derived from event data and portions are derived from user input. Thus, as the sporting event progresses, changes in the sporting event can be incorporated in the virtual environment and presented as game content. Additionally, as the user controls the second virtual character and interacts with the first virtual characters and the environment, these interactions can also be presented as game content. Accordingly, both the event data received and the user input can be incorporated to dynamically update the game content.

In step 260, the first virtual character can include a multitude of first virtual characters. Thus, the first virtual characters can include an entire team or even a group of particular players on a team. Turning to step 265, the actions of the first virtual characters can be correlated to the actions of the individual sporting event participants according to the event data. Thus, even when the first virtual characters include a multitude of virtual characters, the actions of each individual first virtual character can be based on the actions of individual sporting event participants. In such an arrangement, the individual first virtual characters can move independently from each other and individually interact with each other, the environment, and the second virtual characters.

In step 270, user input can be received and the user input can control the actions of the second virtual character. The user input can be commands for the second virtual characters to perform certain actions and/or movements and once received, the game content can be updated accordingly. In one example of an American football game, the user input can command the quarterback to scramble and run out of the pocket along the sidelines.

In step 275, the second virtual character can include a multitude of virtual characters. For instance, the second virtual characters can include an entire team and can also include groups of individual players. It should be noted that the individual second virtual characters can all be controlled by the user; however, in an alternative configuration, the user controls one second virtual character at a time while having the ability to control each second virtual character individually. Therefore, the method 200 is not limited to which second virtual character can be user controlled even when a multitude of second virtual characters is present.

In step 280, the interaction of the first virtual character and the second virtual character can be presented. The interaction can include physical interactions such as touching, pushing, tackling, tripping and so forth, and can also include situation awareness interactions where a change in the positioning and/or formation of the one of the virtual characters causes a change in the other virtual characters. The interaction can be presented on any appropriate device such as a television, monitor, and like. Thus, the user can watch the interaction between the user controlled second virtual characters and the first virtual characters. In step 285, the method 200 can stop or can return to any one of the previous steps for repeating.

The method 200 has been provided for purposes of illustration only and is not to be construed as a limitation of the present invention. Rather, one skilled in the art will recognize that the various steps described with reference to FIG. 2 may be performed in differing order depending upon the particular implementation of the inventive arrangements disclosed herein.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. A method of providing a video game that tracks events in an actual sporting event, comprising the steps of:
generating a virtual environment;
generating at least one first virtual character in said virtual environment;
receiving event data specifying events of a sporting event;
coordinating actions of the first virtual character according to the event data; and
generating at least one user-controlled second virtual character.

2. The method of claim 1, wherein the second virtual character interacts with the first virtual character.

3. The method of claim 1, wherein the actions of the first virtual character occur in near real time with the sporting event.

4. The method of claim 1, wherein the event data specifies the sporting event environment, said method further comprising the step of modeling the virtual environment on event data.

5. The method of claim 1, further comprising the step of updating game content having portions derived from event data and portions derived from user input.

6. The method of claim 1, wherein the first virtual character includes a plurality of first virtual characters.

7. The method of claim 6, further comprising the step of correlating the actions of individual first virtual characters with the actions of an individual sporting event participant according to the event data.

8. The method of claim 1, further comprising the step of receiving user input, wherein the user input controls actions of at least one second virtual character.

9. The method of claim 1, wherein the second virtual character includes a plurality of virtual characters.

10. The method of claim 2, further comprising the step of presenting the interaction of the first virtual character and second virtual character.

11. The method of claim 1, wherein the event data is produced manually.

12. A system for providing a video game experience that tracks events in an actual sporting event, comprising:
at least one gaming system for receiving event data containing events of a sporting event;
at least one gaming engine for generating a virtual environment having at least one first virtual character;
wherein the actions of said first virtual character are based on said event data.

13. The system according to claim 12, wherein said event data contains the environment of the sporting event, said gaming engine generates said virtual environment based on the sporting event environment.

14. The system according to claim 12, wherein said gaming engine generates at least one user-controlled second virtual character.

15. The system according to claim 14, wherein said second virtual character interacts with said first virtual character.

16. The system according to claim 12, wherein the actions of said first virtual character occur in near real time with the sporting event.

17. The system according to claim 14, wherein said gaming engine updates game content having portions derived from event data and portions derived from user input.

18. The system according to claim 12, wherein said gaming engine correlates the actions of individual first virtual characters with the actions of an individual sporting event participant according to said event data.

19. A machine-readable storage, having stored thereon a computer program having a plurality of code sections executable by a machine for causing the machine to perform the steps of:
generating a virtual environment;
generating at least one first virtual character in said virtual environment;
receiving event data specifying events of a sporting event;
coordinating actions of the first virtual character according to the event data; and
generating at least one user-controlled second virtual character.

20. The machine readable storage of claim 17, wherein the second virtual character interacts with the first virtual character.

21. The machine readable storage of claim 17, wherein the actions of the first virtual character occur in near real time with the sporting event.

22. The machine readable storage of claim 17, wherein the event data specifies the sporting event environment, said method further comprising the step of modeling the virtual environment on event data.

23. The machine readable storage of claim 17, further comprising the step of updating game content having portions derived from event data and portions derived from user input.

24. The machine readable storage of claim 17, wherein the first virtual character includes a plurality of first virtual characters.

25. The machine readable storage of claim 24, further comprising the step of correlating the actions of individual first virtual characters with the actions of an individual sporting event participant according to the event data.

26. The machine readable storage of claim 17, further comprising the step of receiving user input, wherein the user input controls actions of at least one second virtual character.

27. The machine readable storage of claim 17, wherein the second virtual character includes a plurality of virtual characters.

28. The machine readable storage of claim 17, further comprising the step of presenting the interaction of the first virtual character and second virtual character.

29. The machine readable storage of claim 17, wherein the event data is produced manually.

30. A system for providing a video game that tracks events in an actual sporting event comprising:
means for generating a virtual environment;
means for generating at least one first virtual character in said virtual environment;
means for receiving event data specifying events of a sporting event;
means for coordinating actions of the first virtual character according to the event data; and
means for generating at least one user-controlled second virtual character.
